(19) United States
(12) Patent Application Publication
(10) Pub. No.: US 2012/0196198 A1
(43) Pub. Date: Aug. 2, 2012

(54) FUEL CELL SYSTEM AND METHOD FOR CONTROLLING THE SAME

(75) Inventor: Kuo-Tai Hung, Hsinchu County (TW)

(73) Assignee: YOUNG GREEN ENERGY CO., HSINCHU COUNTY (TW)

(21) Appl. No.: 13/354,297

(22) Filed: Jan. 19, 2012

(30) Foreign Application Priority Data
Jan. 31, 2011 (CN) 201110036514.9

(51) Int. Cl. H01M 8/04

(52) U.S. Cl. 429/431

(57) ABSTRACT

A method for controlling a fuel cell system is provided, which includes following steps. It is determined whether a hydrogen flow in a fuel cell stack in the fuel cell system is sufficient, and when the hydrogen flow is determined to be sufficient, an output voltage of the fuel cell stack is gradually deceased, and an output current of the fuel cell stack is continually detected until the output current of the fuel cell stack stops increasing. When the hydrogen flow is determined to be insufficient, the output voltage of the fuel cell stack is gradually increased, and the output current of the fuel cell stack is continually detected until the output current of the fuel cell stack starts to decrease.

### CROSS-REFERENCE TO RELATED APPLICATION

This application claims the priority benefit of China application serial no. 201110036514.9, filed on Jan. 31, 2011. The entirety of the above-mentioned patent application is hereby incorporated by reference herein and made a part of this specification.

### BACKGROUND

1. Field of the Invention

The invention relates to a fuel cell system and a method for controlling the same. Particularly, the invention relates to a fuel cell system capable of increasing a fuel utilization rate and having a protection function and a method for controlling the same.

2. Description of Related Art

Development and application of energy have always been indispensable conditions of human life; nevertheless the development and application of energy may cause increasing damage to the environment. Energy from a fuel cell has advantages of high efficiency, low noise, and pollution-free, etc. which is an energy technology in line with a trend of the times. Types of the fuel cells are diversified, and a commonly used one is a proton exchange membrane fuel cell (PEMFC). Moreover, during an operation process of a fuel cell system, how to control an output voltage and an output current of a fuel cell stack to obtain a highest output power and make a full use of the fuel in the fuel cell stack for electric energy conversion have become major performance indexes of the fuel cell system.

Referring to FIG. 1 to FIG. 3 for working properties of the fuel cell stack in the fuel cell system. FIG. 1 is a diagram illustrating a current density-voltage curve of a fuel cell stack under different fuel supplying rates R1-R3 (R1>R2>R3). As shown in FIG. 1, in case of the fuel supplying rate R2, an optimal operating point (voltage and current) of the fuel cell stack is OP2 (V2, I2), and it should be noticed that the magnitude of I in FIGS. 1-2 is converted from current densities. Therefore, if the output current I of the fuel cell stack is set to be greater than the current I2, a phenomenon of insufficient fuel supply is occurred, and the output voltage V of the fuel cell stack is rapidly decreased, which may cause a damage of the fuel cell stack. Moreover, if the output current I of the fuel cell stack is set to be smaller than the current I2, a fuel utilization rate is decreased since a product (V*I) of the output voltage V and the output current I of the fuel cell is smaller than a product (V2*I2) of the voltage V2 and the current I2 corresponding to the optimal operating point OP2.

FIG. 2 is a diagram illustrating a current density-voltage curve of a fuel cell stack under different aging degrees A1-A3 (A3>A2>A1). In case of the aging degree A2 of the fuel cell stack, the optimal operating point (V, I) of the fuel cell stack is the operating point OP2 (V2, I2). When the output voltage V is set to be greater than the voltage V2, the fuel utilization rate is decreased since the product (V*I) of the output voltage V and the output current I of the fuel cell is smaller than the product (V2*I2) of the voltage V2 and the current I2 corresponding to the optimal operating point OP2. Moreover, if the output voltage V is set to be smaller than the voltage V2, the phenomenon of insufficient fuel supply is occurred, which may cause a rapid decline of the output voltage V of the fuel cell stack to damage the fuel cell stack. According to FIG. 1 and FIG. 2, it is known that the operating point of the fuel cell stack has to be set according to the fuel supplying rate or the aging degree of the fuel cell stack, so as to achieve a highest power generating efficiency of the fuel cell stack.

According to the conventional technique, a constant voltage, a constant current or a voltage disturbance observation method is generally used to control the voltage and current operating point of the fuel cell stack, so that the fuel enters the fuel cell stack could be effectively used for electric energy conversion. For example, according to a disclosure of U.S. Pat. No. 5,714874, a constant voltage method is used for controlling an output voltage of a fuel cell stack between 27V and 28V. When the output voltage of the fuel cell stack is greater than 28V, a maximum output current of the fuel cell stack is increased. Moreover, when the output voltage of the fuel cell stack is lower than 27V, the maximum output current of the fuel cell stack is decreased.

However, the constant voltage control method is only adapted to a fuel cell system with a fixed fuel flow, which is not adapted to a fuel cell system with a varied fuel flow. When the constant voltage control method is applied to the fuel cell system with a varied fuel flow, in case of lack of fuel or excess of fuel, a power generating efficiency of the fuel cell stack is relatively low. Moreover, when the constant voltage control method is applied to an aged fuel cell stack, since an operating point of the aged fuel cell stack is shifted, the fuel utilization rate is decreased.

On the other hand, according to a disclosure of U.S. Publication No. 2006/0029844, a voltage disturbance observation method is used to obtain a maximum output power point of a fuel cell stack. However, when a hydrogen flow of the fuel cell stack is insufficient, the fuel cell stack is liable to operate at an improper operating point, which may reduce lifetime of the fuel cell stack.

Moreover, Taiwan Publication No. 201004018 and No. 200905960, and U.S. Publication No. 2007/0196700 and No. 2010/0173211 respectively disclose a control method of a fuel cell system.

### SUMMARY OF THE INVENTION

The invention is directed to a method for controlling a fuel cell system, by which an output voltage of a stack could be dynamically adjusted according to a hydrogen flow status, so that the fuel cell stack may have a higher output power, and fuel enters the fuel cell stack could be effectively used for electric energy conversion.

The invention is directed to a fuel cell system, which could stably work to maintain a high power generating efficiency and a longer lifetime of fuel cell stack.

Other aspects and advantages of the invention will be set forth in the description of the techniques disclosed in the invention.

To achieve one of or all aforementioned and other advantages, an embodiment of the invention provides a method for controlling a fuel cell system, which includes following steps. It is determined whether a hydrogen flow in a fuel cell stack of the fuel cell system is sufficient. When the hydrogen flow is determined to be sufficient, an output voltage of the fuel cell stack is gradually deceased, and an output current of the fuel cell stack is continually detected until the output current of the fuel cell stack stops increasing. When the hydrogen flow is determined to be insufficient, the output voltage of the fuel cell stack is gradually increased, and the output current of the fuel cell stack is continually detected until the output current of the fuel cell stack starts to decrease.

In an embodiment of the invention, whether the hydrogen flow in the fuel cell stack is sufficient is determined according to a flag, and the flag has a first state and a second state respectively representing sufficiency and insufficiency of the hydrogen flow in the fuel cell stack.

In an embodiment of the invention, when the output current of the fuel cell stack stops increasing, the method further includes following steps. It is determined whether a variation value of the output current of the fuel cell stack is greater than a predetermined value. When the variation value is greater than the predetermined value, a maximum of the output current of the fuel cell stack is updated, the output voltage of the fuel cell stack is gradually increased, and the output current of the fuel cell stack is continually detected until the output current of the fuel cell stack starts to decrease. When the variation value is smaller than the predetermined value, the output voltage of the fuel cell stack is gradually increased and the output current of the fuel cell stack is continually detected until the output current of the fuel cell stack starts to decrease.

In an embodiment of the invention, before the variation value of the output current of the fuel cell stack is determined, the method further includes setting the flag to the second state.

In an embodiment of the invention, when the output current of the fuel cell stack starts to decrease, the method further includes setting the flag to the first state.

In an embodiment of the invention, before the step of determining whether the hydrogen flow in the fuel cell stack is sufficient, the method further includes performing a slow start procedure to make the fuel cell stack suitable for operation.

In an embodiment of the invention, the variation value is a difference between the maximum of the output current and the output current.

The invention provides a fuel cell system including a fuel cell stack, a detection unit, a conversion unit, and a processing unit. The fuel cell stack is used for carrying out a chemical reaction to produce electric energy. The detection unit is coupled to the fuel cell stack for detecting an output voltage and an output current of the fuel cell stack. The conversion unit is coupled to the fuel cell stack for converting the output voltage and the output current of the fuel cell stack. The processing unit is coupled to the detection unit and the conversion unit for determining whether a hydrogen flow in the fuel cell stack is sufficient. When the hydrogen flow is determined to be sufficient, the processing unit controls the conversion unit to gradually decrease the output voltage of the fuel cell stack, and the detection unit continually detects the output current of the fuel cell stack until the output current of the fuel cell stack stops increasing. When the hydrogen flow is determined to be insufficient, the processing unit controls the conversion unit to gradually increase the output voltage of the fuel cell stack, and the detection unit continually detects the output current of the fuel cell stack until the output current of the fuel cell stack starts to decrease.

In an embodiment of the invention, the processing unit determines whether the hydrogen flow in the fuel cell stack is sufficient according to a flag. Herein the flag has a first state and a second state respectively representing sufficiency and insufficiency of the hydrogen flow in the fuel cell stack.

In an embodiment of the invention, when the output current of the fuel cell stack stops increasing, the processing unit determines whether a variation value of the output current of the fuel cell stack is greater than a predetermined value. When the variation value is greater than the predetermined value, the processing unit updates a maximum of the output current of the fuel cell stack and controls the conversion unit to gradually increase the output voltage of the fuel cell stack, and the detection unit continually detects the output current of the fuel cell stack until the output current of the fuel cell stack starts to decrease. When the variation value is smaller than the predetermined value, the processing unit controls the conversion unit to gradually increase the output voltage of the fuel cell stack and the detection unit continually detects the output current of the fuel cell stack until the output current of the fuel cell stack starts to decrease.

In an embodiment of the invention, the processing unit sets the flag to the second state before determining the variation value of the output current of the fuel cell stack.

In an embodiment of the invention, the processing unit sets the flag to the first state when the output current of the fuel cell stack starts to decrease.

According to the above descriptions, in the embodiment of the invention, the output voltage of the fuel cell stack could be dynamically adjusted, so that fuel enters the fuel cell stack could be effectively used for electric energy conversion to achieve a better fuel utilization rate.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a current density-voltage curve (I-V curve) of a fuel cell stack under different fuel supplying rates R1-R3 (R1>R2>R3).

FIG. 2 is a diagram illustrating a current density-voltage curve (I-V curve) of a fuel cell stack under different aging degrees A1-A3 (A3>A2>A1).

FIG. 3 is a block diagram of a fuel cell system according to an embodiment of the invention.

FIG. 4 is an operation schematic diagram of an embodiment of the invention.

FIG. 5 is a flowchart illustrating a method for controlling a fuel cell system according to an embodiment of the invention.

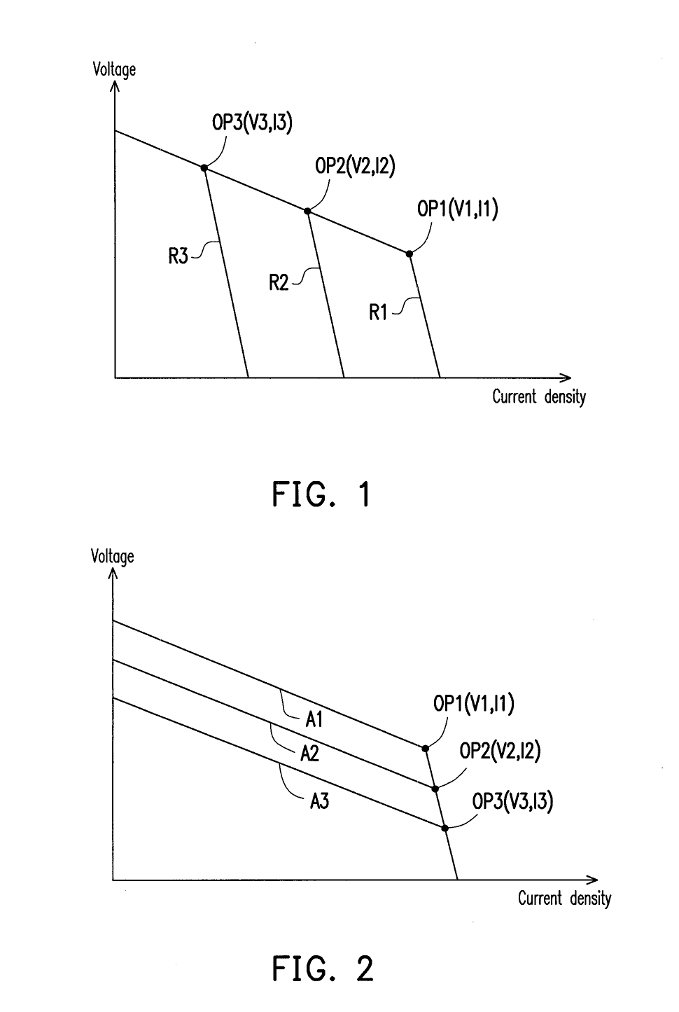

### DETAILED DESCRIPTION OF DISCLOSED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

Moreover, wherever possible, like reference numerals in the drawings denote like devices/elements/steps.

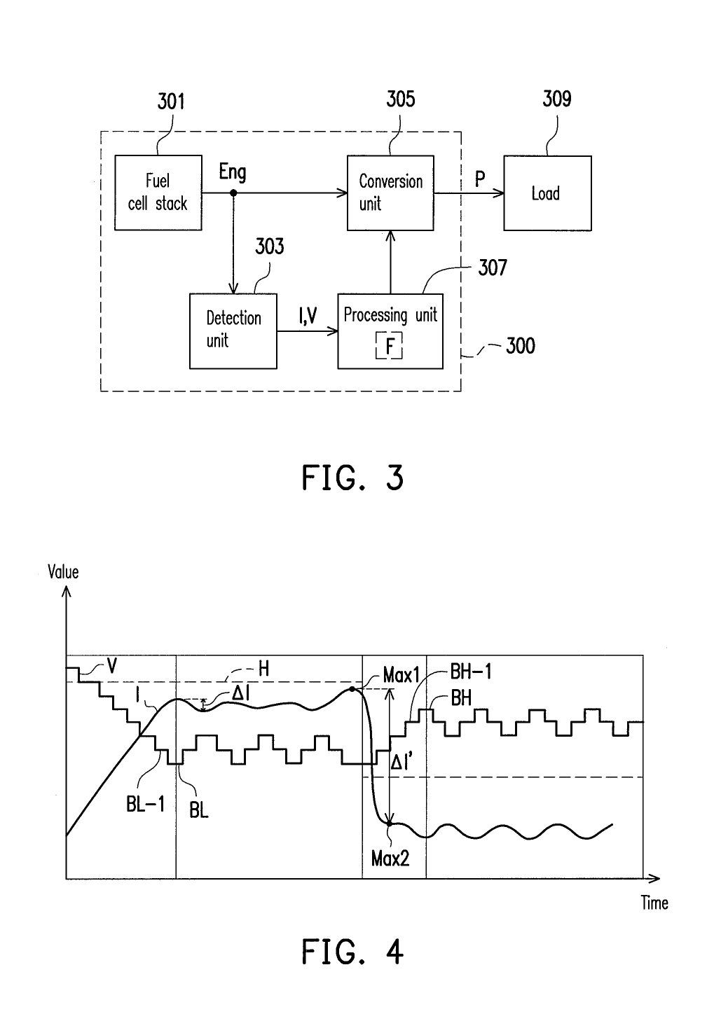

FIG. 3 is a block diagram of a fuel cell system 300 according to an embodiment of the invention. Referring to FIG. 3, the fuel cell system 300 includes a fuel cell stack 301, a detection unit 303, a conversion unit 305, and a processing unit 307. In the embodiment, the fuel cell stack 301 may carry out a chemical reaction to output electric energy Eng. To be specific, the fuel cell stack 301 could be a proton exchange membrane fuel cell stack (PEMFC stack) or a direct methanol fuel cell stack (DMFC stack).

The detection unit 303 is coupled to the fuel cell stack 301 for detecting an output voltage V and an output current I of the fuel cell stack 301. The conversion unit 305 is coupled to the fuel cell stack 301 for converting the output voltage V and the output current I of the fuel cell stack 301, so as to provide power P to a load 309 (for example, an electronic device) for utilization.

The processing unit 307 is coupled to the detection unit 303 and the conversion unit 305 for determining whether a hydrogen flow in the fuel cell stack 301 is sufficient. In the embodiment, the processing unit 307 determines whether the hydrogen flow in the fuel cell stack 301 is sufficient according to a flag F which has a first state (for example, logic “0”) and a second state (for example, logic “1”) respectively representing sufficiency and insufficiency of the hydrogen flow in the fuel cell stack 301. In other embodiments of the invention, the first state and the second state could respectively represent insufficiency and sufficiency of the hydrogen flow in the fuel cell stack 301, which is determined by design requirement.

When the processing unit 307 determines that the hydrogen flow is sufficient (i.e. the flag F is logic “0”), the processing unit 307 controls the conversion unit 305 to gradually decrease the output voltage (V) of the fuel cell stack 301, and the detection unit 303 continually detects the output current (I) of the fuel cell stack 301 until the output current of the fuel cell stack 301 stops increasing. Conversely, when the processing unit 307 determines that the hydrogen flow is insufficient (i.e. the flag F is logic “1”), the processing unit 307 controls the conversion unit 305 to gradually increase the output voltage of the fuel cell stack 301, and the detection unit 303 continually detects the output current of the fuel cell stack 301 until the output current I of the fuel cell stack 301 starts to decrease.

Moreover, when the processing unit 307 detects that the output current I of the fuel cell stack 301 stops increasing by the detection unit 303, the processing unit 307 determines whether a variation value of the output current of the fuel cell stack 301 is greater than a predetermined value (which is determined according to an actual design requirement). When the processing unit 307 determines that the variation value of the output current of the fuel cell stack 301 is greater than the predetermined value, the processing unit 307 updates a maximum of the output current of the fuel cell stack 301, and controls the conversion unit 305 to gradually increase the output voltage of the fuel cell stack 301 and continually detects the output current of the fuel cell stack 301 by the detection unit 303 until the output current I of the fuel cell stack 301 starts to decrease. Conversely, when the processing unit 307 determines that the variation value of the output current of the fuel cell stack 301 is smaller than the predetermined value, the processing unit 307 controls the conversion unit 305 to gradually increase the output voltage V of the fuel cell stack 301 and continually detects the output current I of the fuel cell stack 301 by the detection unit 303 until the output current I of the fuel cell stack 301 starts to decrease.

Moreover, the processing unit 307 sets the flag F to the second state (i.e. the logic “1”) before determining the variation value of the output current I of the fuel cell stack 301. Moreover, the processing unit 307 sets the flag F to the first state (i.e. the logic “0”) when detecting that the output current I of the fuel cell stack 301 starts to decrease.

Based on the above description, FIG. 4 is an operation schematic diagram of an embodiment of the invention. Referring to FIG. 3 and FIG. 4, when the flag F is in the first state (the logic “0”), the processing unit 307 determines that the hydrogen flow in the fuel cell stack 301 is sufficient, and controls the conversion unit 305 to gradually decrease (for example, decrease in a stepped manner) the output voltage of the fuel cell stack 301 and continually detects the output current of the fuel cell stack 301 by the detection unit 303 until the output current I of the fuel cell stack 301 stops increasing.

Once the processing unit 307 detects that the output current I of the fuel cell stack 301 stops increasing by the detection unit 303, the processing unit 307 sets the flag F to the second state (the logic “1”), and adjusts the output voltage V of the fuel cell stack 301 to a previous step voltage BL-1 corresponding to a lowest step voltage BL by the conversion unit 305, so as to determine whether a variation value ΔI of the output current I of the fuel cell stack 301 is greater than the predetermined value. The variation value ΔI is, for example, a difference between a maximum Max of the output current and the output current I, i.e. ΔI=Max-I. The predetermined value could be 3% of the maximum Max of the output current of the fuel cell stack 301, though the invention is not limited thereto.

When the processing unit 307 determines that the variation value ΔI of the output current I of the fuel cell stack 301 is smaller than the predetermined value, the processing unit 307 controls the conversion unit 305 to gradually increase (for example, increase in the stepped manner) the output voltage V of the fuel cell stack 301 and continually detects the output current I of the fuel cell stack 301 by the detection unit 303 until the output current I of the fuel cell stack 301 starts to decrease, i.e. the output current I starts to decrease from a high point. Once the processing unit 307 detects that the output current I of the fuel cell stack 301 starts to decrease, the processing unit 307 sets the flag F to the first state (i.e. the logic “0”), and re-performs operations similar as that the hydrogen flow H in the fuel cell stack 301 is sufficient.

Moreover, when the processing unit 307 determines that the variation value ΔI of the output current I of the fuel cell stack 301 is greater than the predetermined value (i.e. 3% of the maximum Max of the output current I of the fuel cell stack 301), it represents that the hydrogen flow H in the fuel cell stack 301 is probably insufficient. Therefore, the processing unit 307 updates the maximum Max of the output current I of the fuel cell stack 301 (i.e. updates from a maximum Max1 to a maximum Max2), and controls the conversion unit 305 to gradually increase the output voltage V of the fuel cell stack 301 and continually detects the output current I of the fuel cell stack 301 by the detection unit 303 until the output current I of the fuel cell stack 301 starts to decrease, i.e. the output current I starts to decrease from a high point. Once the processing unit 307 detects that the output current I of the fuel cell stack 301 starts to decrease, the processing unit 307 sets the flag F to the first state (i.e. the logic “0”), and adjusts the output voltage V of the fuel cell stack 301 to a previous step voltage BH-1 corresponding to a highest step voltage BH by the conversion unit 305, and re-performs operations similar as that the hydrogen flow H in internal of the fuel cell stack 301 is sufficient.

Similarly, when the processing unit 307 determines that the hydrogen flow H in the fuel cell stack 301 is insufficient according to the flag F, i.e. the flag F in the second state (the logic “1”), the processing unit 307 controls the conversion unit 305 to gradually increase (for example, increase in the stepped manner) the output voltage of the fuel cell stack 301 and continually detects the output current of the fuel cell stack 301 by the detection unit 303 until the output current I of the fuel cell stack 301 starts to decrease, i.e. the output current I starts to decrease from a high point. Once the processing unit 307 detects that the output current I of the fuel cell stack 301 starts to decrease, the processing unit 307 sets the flag F to the first state (i.e. the logic “0”), and adjusts the output voltage of the fuel cell stack 301 to the previous step voltage BH-1 corresponding to the highest step voltage BH through the conversion unit 305, and re-performs operations similar as that the hydrogen flow H in internal of the fuel cell stack 301 is sufficient.

Therefore, the processing unit 307 adjusts the output voltage of the fuel cell stack according to a magnitude of the hydrogen flow in the fuel cell stack 301, and accordingly adjusts the output current of the fuel cell stack 301, so that the fuel cell stack 301 may operate at a better operating point. In other words, the processing unit 307 takes the output voltage of the fuel cell stack 301 as a control item, and takes the output current of the fuel cell stack 301 as an observation item, and observes a variation of a current operating point of the fuel cell stack 301 by controlling a voltage operating point of the fuel cell stack 301 through a stepped adjustment method, so as to determine whether the operating point of the fuel cell stack 301 is proper. In this way, regardless whether the hydrogen flow in the fuel cell stack 301 is sufficient or insufficient, the processing unit 307 could control the fuel cell stack 301 to operate at a proper operating point, so that the fuel enters the fuel cell stack 301 could be effectively used for electric energy conversion, so as to improve the fuel utilization rate.

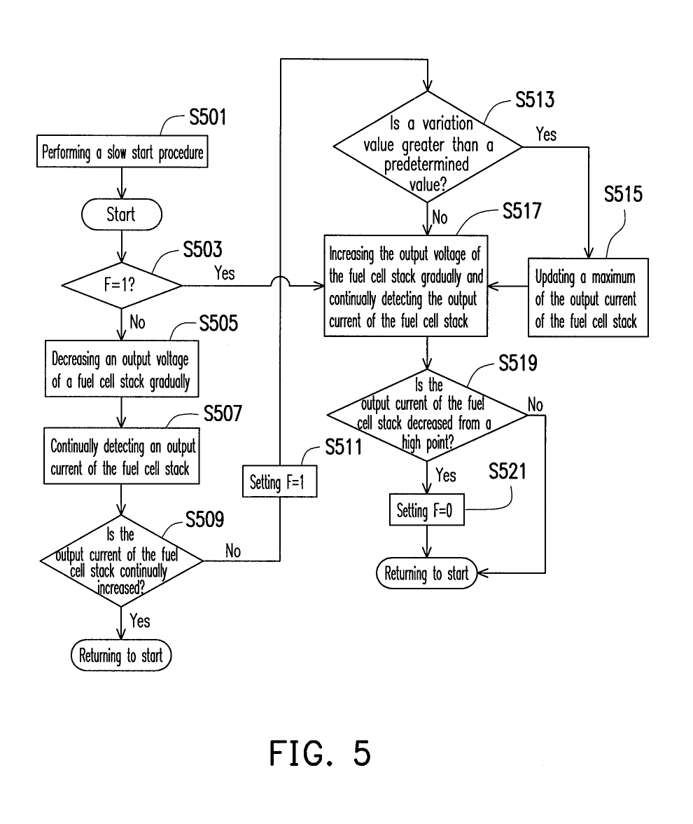

Based on the disclosure/teaching of the above embodiment, FIG. 5 is a flowchart illustrating a method for controlling a fuel cell system according to an embodiment of the invention. Referring to FIG. 5, the method for controlling the fuel cell system of the embodiment (which could be regarded as a configuration of a micro control unit of the aforementioned embodiment) includes following steps.

Before the fuel cell stack of the fuel cell system formally operates, a slow start procedure is performed (step S501) to make the fuel cell stack suitable for operation, namely, waiting for sufficient fuel to enter flow channels of the fuel cell stack, to wet the fuel cell stack, and to increase a temperature of the fuel cell stack to a degree suitable for operation. After the slow start procedure is performed, the fuel cell stack starts to operate.

After the fuel cell stack starts to operate, it is determined whether a hydrogen flow in the fuel cell stack is sufficient (step S503). In the embodiment, whether the hydrogen flow in the fuel cell stack is sufficient could be determined according to a flag F, where the flag has a first state (for example, logic “0”) and a second state (for example, logic “1”) respectively representing sufficiency and insufficiency of the hydrogen flow in the fuel cell stack. Certainly, in other embodiments of the invention, the first state and the second state could respectively represent insufficiency and sufficiency of the hydrogen flow in the fuel cell stack, which is determined according to an actual design requirement.

When it is determined that the hydrogen flow in the fuel cell stack is sufficient in step S503 (i.e. F≠1), an output voltage of the fuel cell stack is gradually deceased (step S505), and an output current of the fuel cell stack is continually detected (step S507), so as to determine whether the output current of the fuel cell stack is continually increased (step S509). If the output current of the fuel cell stack is continually increased, return to the start until the output current of the fuel cell stack stops increasing.

Once the output current of the fuel cell stack stops increasing, the flag F is set to the second state (i.e. F=1) (step S511), and it is determined whether a variation value of the output current of the fuel cell stack is greater than a predetermined value (step S513).

When the variation value of the output current of the fuel cell stack is greater than the predetermined value, a maximum of the output current of the fuel cell stack is updated (step S515), and the output voltage of the fuel cell stack is gradually increased and the output current of the fuel cell stack is continually detected (step S517), so as to determine whether the output current of the fuel cell stack decreases from a high point (step S519). If the output current of the fuel cell stack does not decrease from the high point, return to the start until the output current of the fuel cell stack starts to decrease, i.e. the output current of the fuel cell stack decreases from the high point. However, if it is determined that the output current of the fuel cell stack decreases from the high point in the step S519, the flag F is set to the first state (i.e. F=0) (step S521), and return to the start.

On the other hand, when the variation value of the output current of the fuel cell stack is smaller than the predetermined value, or when it is determined that the hydrogen flow in the fuel cell stack is insufficient (i.e. F=1) in the step S503, the output voltage of the fuel cell stack is gradually increased and the output current of the fuel cell stack is continually detected (the step S517), so as to determine whether the output current of the fuel cell stack decreases from a high point (step S519). Similarly, if the output current of the fuel cell stack does not decrease from the high point, return to the start until the output current of the fuel cell stack starts to decrease, i.e. the output current of the fuel cell stack decreases from the high point. However, if it is determined that the output current of the fuel cell stack decreases from the high point in the step S519, the flag F is set to the first state (i.e. F=0) (step S521), and return to the start.

In summary, according to the embodiments of the invention, at least one of the following advantages could be implemented:
1. The output voltage of the fuel cell stack is dynamically adjusted, which is adapted to a fuel cell system having a varied fuel supplying environment (i.e. a varied fuel flow).
2. Presetting of a fixed/specific voltage operating point is unnecessary, which is adapted to the fuel cell stacks with different aging degrees.
3. Compared to the constant voltage control method of the related art, the fuel entering the fuel cell stack could be effectively used for electric energy conversion to achieve a better fuel utilization rate.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A method for controlling a fuel cell system, comprising:
determining whether a hydrogen flow in a fuel cell stack of the fuel cell system is sufficient;
deceasing an output voltage of the fuel cell stack gradually when the hydrogen flow is determined to be sufficient, and continually detecting an output current of the fuel cell stack until the output current stops increasing; and
increasing the output voltage gradually when the hydrogen flow is determined to be insufficient, and continually detecting the output current until the output current starts to decrease.

2. The method for controlling the fuel cell system as claimed in claim 1, wherein whether the hydrogen flow in the fuel cell stack is sufficient is determined according to a flag, and the flag has a first state and a second state respectively representing sufficiency and insufficiency of the hydrogen flow in the fuel cell stack.

3. The method for controlling the fuel cell system as claimed in claim 2, wherein when the output current stops increasing, the method further comprises:
determining whether a variation value of the output current is greater than a predetermined value;
updating a maximum of the output current when the variation value is greater than the predetermined value, and gradually increasing the output voltage and continually detecting the output current until the output current starts to decrease; and
increasing the output voltage gradually and continually detecting the output current until the output current starts to decrease when the variation value is smaller than the predetermined value.

4. The method for controlling the fuel cell system as claimed in claim 3, wherein the method further comprises setting the flag to the second state before the variation value is determined.

5. The method for controlling the fuel cell system as claimed in claim 3, wherein the method further comprises setting the flag to the first state when the output current starts to decrease.

6. The method for controlling the fuel cell system as claimed in claim 3, wherein the method further comprises performing a slow start procedure to make the fuel cell stack suitable for operation before the step of determining whether the hydrogen flow in the fuel cell stack is sufficient,.

7. The method for controlling the fuel cell system as claimed in claim 3, wherein the variation value is a difference between the maximum of the output current and the output current.

8. A fuel cell system, comprising:
a fuel cell stack, for carrying out a chemical reaction to produce electric energy;
a detection unit, coupled to the fuel cell stack, for detecting an output voltage and an output current of the fuel cell stack;
a conversion unit, coupled to the fuel cell stack, for converting the output voltage and the output current; and
a processing unit, coupled to the detection unit and the conversion unit, for determining whether a hydrogen flow in the fuel cell stack is sufficient;
wherein when the hydrogen flow is determined to be sufficient, the processing unit controls the conversion unit to gradually decrease the output voltage, and the detection unit continually detects the output current until the output current stops increasing, and when the hydrogen flow is determined to be insufficient, the processing unit controls the conversion unit to gradually increase the output voltage, and the detection unit continually detects the output current until the output current starts to decrease.

9. The fuel cell system as claimed in claim 8, wherein the processing unit determines whether the hydrogen flow in the fuel cell stack is sufficient according to a flag.

10. The fuel cell system as claimed in claim 9, wherein the flag has a first state and a second state respectively representing sufficiency and insufficiency of the hydrogen flow in the fuel cell stack.

11. The fuel cell system as claimed in claim 10, wherein when the output current stops increasing, the processing unit determines whether a variation value of the output current is greater than a predetermined value; when the variation value is greater than the predetermined value, the processing unit updates a maximum of the output current, the conversion unit is controlled to gradually increase the output voltage, and the detection unit continually detects the output current until the output current starts to decrease; and when the variation value is smaller than the predetermined value, the processing unit controls the conversion unit to gradually increase the output voltage and the detection unit continually detects the output current until the output current starts to decrease.

12. The fuel cell system as claimed in claim 11, wherein the processing unit sets the flag to the second state before determining the variation value.

13. The fuel cell system as claimed in claim 11, wherein the processing unit sets the flag to the first state when the output current starts to decrease.

14. The fuel cell system as claimed in claim 11, wherein the variation value is a difference between the maximum of the output current and the output current.
